(19) United States
(12) Patent Application Publication
(10) Pub. No.: US 2015/0339738 A1
(43) Pub. Date: Nov. 26, 2015

(54) METHOD TO VALIDATE SHIPPING RATES

(71) Applicant: Raghu Munaswamy, Santa Clara, CA (US)

(72) Inventor: Raghu Munaswamy, Santa Clara, CA (US)

(73) Assignee: EBAY INC., SAN JOSE, CA (US)

(21) Appl. No.: 14/285,388

(22) Filed: May 22, 2014

(51) Int. Cl. G06Q 30/02

(52) U.S. Cl. CPC G06Q 30/0283; G06Q 2250/80

(57) ABSTRACT

An actual shipping rates table and a stored shipping rates table are retrieved. A first aggregate value from the sum of all values in the actual shipping rates table and a second aggregate value from the sum of all values in the stored shipping rates table are computed. The first aggregate value is compared with the second aggregate value. A third aggregate value along a field with the most number of values of the actual shipping rates table, and a fourth aggregate value along a field with the most number of values of the stored shipping rates table are computed. The third aggregate value is compared with the fourth aggregate value. The stored shipping rates table is validated when the first aggregate value matches the second aggregate value, and the third aggregate value matches the fourth aggregated value.

### TECHNICAL FIELD

This application relates generally to the field of computer technology and, in a specific example embodiment, to a system and method for validating shipping rates.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

The website may also allow sellers to print shipping labels from multiple shipping carriers associated with the website. Shipping rate tables for each shipping carrier may vary by seller category, postal zones, package weight, package dimensions, and shipping service. Different shipping rates tables may exist (e.g., one for sellers and another one for the website), resulting in an enormous number of combinations.

For example, a shipping service provider may have thousands of shipping rate values that vary based on seller tier and product category. With rates changing every few months and with a short window to validate them before the website community sees it, a need exists for a more efficient way to validate shipping rates quickly without compromising the accuracy of the shipping rates loaded.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram depicting various components of a network-based publication system, in accordance with some embodiments;

FIG. 3 is a block diagram depicting various components of a shipping rate validation application, in accordance with some embodiments;

FIG. 4 is a flow diagram illustrating an example embodiment of a process for the shipping rate validation application;

FIG. 5 is a flow diagram illustrating another example embodiment of a process for the shipping rate validation application;

FIG. 6 illustrates examples of shipping rate tables being processed by the shipping rate validation application;

FIGS. 7A, 7B, 7C illustrate examples of shipping rate tables being processed by the shipping rate validation application; and

FIG. 8 shows a diagrammatic representation of a machine in the example form of a computer system within which a set of instructions may be executed to cause the machine to perform any one or more of the methodologies discussed herein.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In an example embodiment, a shipping rate validation application of a marketplace application accesses an actual shipping rates table and a stored shipping rates table. The actual shipping rates table comprises updated shipping rates provided from a shipping carrier. For example, the actual shipping rates table may be the latest provided or published shipping rates table from the shipping carrier. The stored shipping rates table may include a shipping rates table accessed by the shipping rate validation application. For example, the shipping rates table may include the last shipping rates table downloaded from the shipping carrier and stored in a storage device associated with the shipping rate validation application. As such, the stored shipping rates table may differ from the actual shipping rates table when the shipping carrier updates their shipping rates.

Shipping rates tables may include shipping rates values for each shipping carrier and may vary by seller category related to the marketplace application, postal zones, package weight, package dimensions, and shipping service. Different shipping rates tables may exist (e.g., one for sellers and another one for the website), resulting in an enormous number of combinations. A seller category may be defined based on, for example, sales history of the seller on the marketplace application.

In an example embodiment, the shipping rate validation application computes a first aggregate value from the sum of all values in the actual shipping rates table, and a second aggregate value from the sum of all values in the stored shipping rates table. The shipping rate validation application compares the first aggregate value with the second aggregate value. The shipping rate validation application computes a third aggregate value along a field with the most number of values (e.g., weight) of the actual shipping rates table, and a fourth aggregate value along a field with the most number of values of the stored shipping rates table. The shipping rate validation application compares the third aggregate value with the fourth aggregate value. The shipping rate validation application validates the stored shipping rates table when the first aggregate value matches the second aggregate value, and the third aggregate value matches the fourth aggregated value. In addition to above steps, the validation process can compute and compare aggregates along with zone vector. Repeating these steps along both vectors of the matrix allows a higher level of accuracy.

In one example embodiment, the shipping rate validation application identifies a field having an error in the stored shipping rates table based on the comparison between the third aggregate value with the fourth aggregate value. The shipping rate validation application computes a fifth aggregate value along a field with the least number of values of the actual shipping rates table, and a sixth aggregate value along a field with the least number of values of the stored shipping rates table. The shipping rate validation application compares the fifth aggregate value with the sixth aggregate value to identify a shipping rate error within the field having the error in the stored shipping rates table. The fifth and sixth aggregate values along the field with least number of values are also compared as part of validation.

In another example embodiment, the shipping rate validation application validates the stored shipping rates table based on the comparison between the first aggregate value with the second aggregate value, between the third aggregate value with the fourth aggregate value, and between the fifth aggregate value with the sixth aggregate value.

In another example embodiment, the shipping rate validation application reduces the actual and stored shipping rates tables to a two-dimensional matrix having shipping weight fields as a first dimension and shipping zone fields as a second dimension. The shipping rate validation application identifies a shipping weight field having the shipping rate error by comparing aggregated values along the shipping zone fields; and identifies the shipping zone field having the shipping rate error by comparing values along the identified shipping weight field.

The field with the most number of values includes a shipping weight field. The field with the least number of values includes a shipping zone field.

In another example embodiment, the shipping rate validation application retrieves an actual shipping rates table for a shipping service and a stored shipping rates table for the shipping service. The shipping rate validation application then computes an actual service aggregate value based on the sum of all values in the actual shipping rates table for the shipping service, and a stored service aggregate value from the sum of all values in the stored shipping rates table for the shipping service.

In another example embodiment, the shipping rate validation application retrieves the actual shipping rates table for a shipping service of a shipping service provider from a server associated with the shipping service provider, and retrieves the stored shipping rates table for the shipping service of the shipping service provider from a database of an online marketplace application.

In another example embodiment, the shipping rate validation application retrieves an actual shipping rates table corresponding to a seller tier of an online marketplace application. The shipping rate validation application then computes an actual service aggregate value based on the sum of all values in the actual shipping rates table for the corresponding seller tier, and a stored service aggregate value from the sum of all values in the stored shipping rates table for the corresponding seller tier.

In another example embodiment, a storage device of the marketplace application stores the shipping rates tables with corresponding shipping services, shipping service providers, and seller tiers.

In another example embodiment, the shipping rate validation application communicates with a plurality of servers associated with corresponding shipping service providers to retrieve actual shipping rates tables, and generates a shipping label to a seller of an online marketplace after validating the stored shipping rates tables.

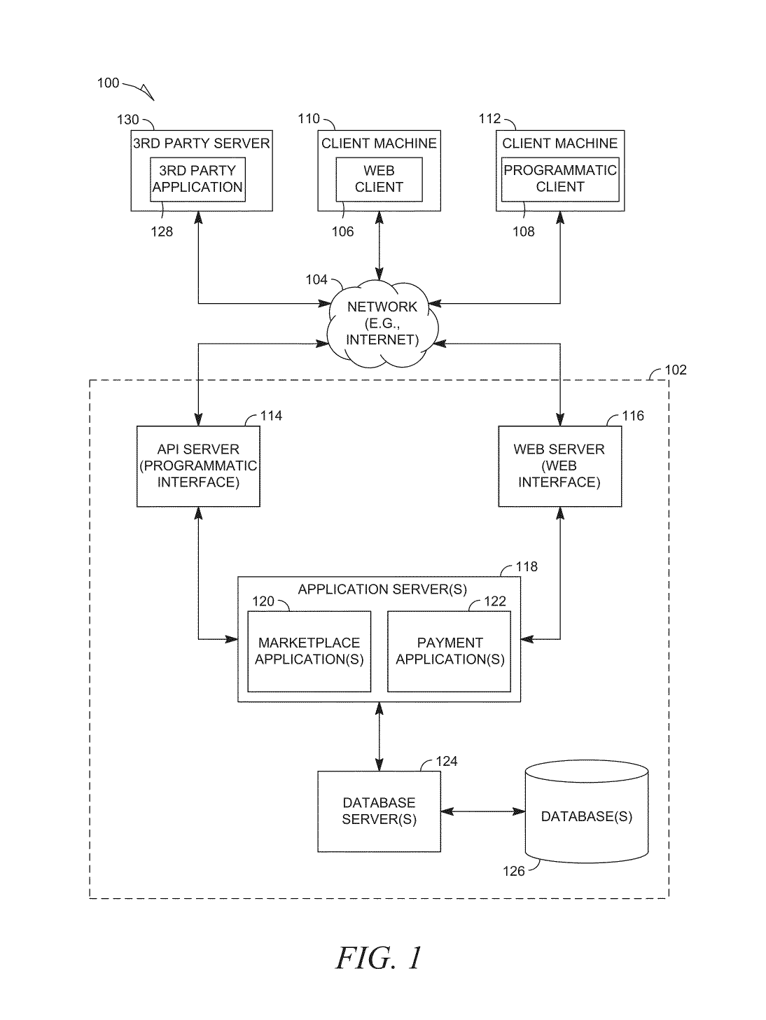

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course, not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

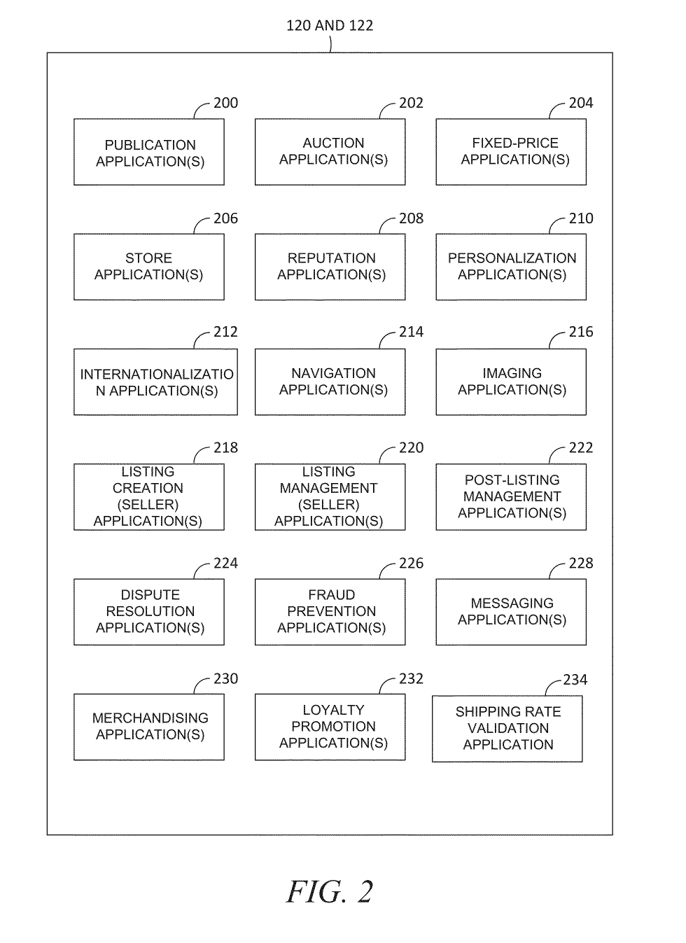

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), short message service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

A shipping rate validation application 234 is responsible for validating shipping rates based on stored shipping rates and updated or actual shipping rates from shipping service providers. The values of the shipping rates may be stored in multi-dimensional tables since tables may vary based on the shipping service provider, seller tier, weight, shipping zones, shipping distances, and other parameters. Instead of comparing every single value from the shipping rates tables, the shipping rate validation application 234 operates an algorithm that efficiently determines whether the values in the shipping rates tables previously acquired by the marketplace application 120 are the same values from updated shipping rates tables. If the values are the same, the shipping rates tables are validated.

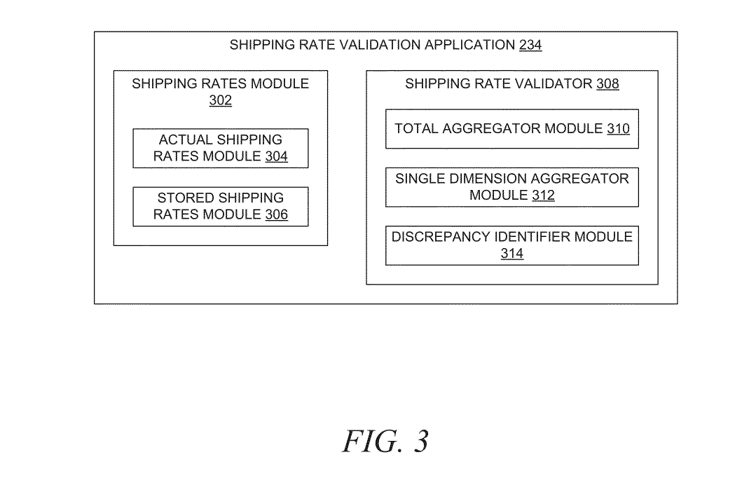

FIG. 3 is a block diagram illustrating an example embodiment of the shipping rate validation application 234. In one embodiment, the shipping rate validation application 234 includes a shipping rates module 302 and a shipping rate validator 308.

The shipping rates module 302 accesses the stored shipping rates tables from the marketplace application 120. Stored shipping rates tables include shipping rates tables that have been previously retrieved and stored by the marketplace application 120. The shipping rates module 302 also retrieves updated or actual shipping rates tables from servers of the shipping service providers. The shipping rates module 302 may be configured to retrieve the updated or new shipping rates tables on a periodic basis (every six months). In another example, the new shipping rates tables may be dynamically pushed or published to the shipping rates module 302 by the servers of the shipping service providers when new shipping rates are in effect. In one embodiment, the shipping rates module 302 may include an actual shipping rates module 304 and a stored shipping rates module 306. The actual shipping rates module 304 may retrieve the new shipping rates from the servers of the shipping service providers. The stored shipping rates module 306 may retrieve the shipping rates stored by the marketplace application 120.

The shipping rate validator 308 compares the actual shipping rates to the stored shipping rates to validate the stored shipping rates. In one example embodiment, the shipping rate validator 308 may include a total aggregator module 310, a single dimension aggregator module 312, and a discrepancy identifier module 314. The total aggregator module 310 computes a first aggregate value from the sum of all values in the actual shipping rates table and a second aggregate value from the sum of all values in the stored shipping rates table. The total aggregator module 310 compares the first aggregate value with the second aggregate value. The single dimension aggregator module 312 computes a third aggregate value along a field with the most number of values (e.g., weight) of the actual shipping rates table, and a fourth aggregate value along a field with the most number of values of the stored shipping rates table. The single dimension aggregator module 312 compares the third aggregate value with the fourth aggregate value. The discrepancy identifier module 314 validates the stored shipping rates table when the first aggregate value matches the second aggregate value, and the third aggregate value matches the fourth aggregated value. If there is a discrepancy in the shipping rate value, the discrepancy identifier module 314 identifies the outdated shipping rate. The shipping rate validator 308 may notify a user that the shipping rates are not valid or not up to date and request for user intervention. In another example, the shipping rate validator 308 displays to the user the outdated shipping rate along with the updated shipping rate. The shipping rate validator 308 may request the user to confirm whether to update the shipping rate table to correct the discrepancy.

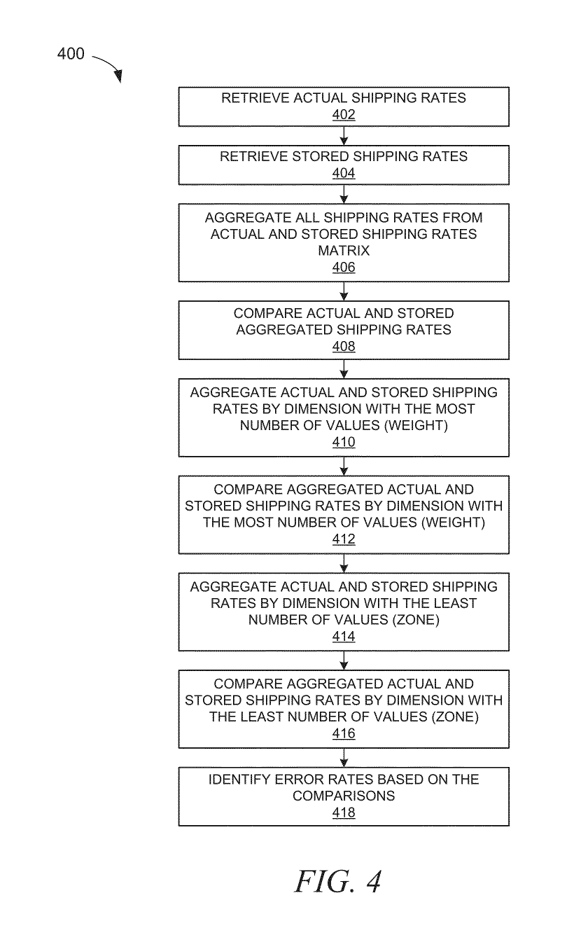

FIG. 4 is a flow diagram illustrating an example embodiment of a method 400 for validating shipping rates. At 402, the shipping rate validation application 234 retrieves actual or latest shipping rates from a shipping service provider. At 404, the shipping rate validation application 234 retrieves shipping rates currently stored or last retrieved by the shipping rate validation application 234. The shipping rates may include a multi-dimensional matrix or tables. At 406, the shipping rate validation application aggregates all the shipping rates from the actual and stored shipping rates matrices. At 408, the shipping rate validation application compares the actual and stored aggregated shipping rates. At 410, the shipping rate validation application compares the aggregated actual and stored shipping rates by dimension with the most number of fields or values (e.g., weight). At 412, the shipping rate validation application compares the aggregated actual and stored shipping rates by dimension with the least number of fields or values (e.g., shipping zone). For example, a shipping rate table may have more fields for the weight (e.g., 1 oz, 5 oz, 10 oz, etc.) than fields for the shipping zone (e.g., zone 1, zone 2, etc.). At 414,the shipping rate validation application aggregates the actual and stored shipping rates by a dimension/vector with the least number of fields or values (e.g., shipping zone). At 416, the shipping rate validation application compares the aggregated actual and stored shipping rates by the dimension/vector with the least number of fields or values (e.g., shipping zone). At 418, the shipping rate validation application identifies shipping rates with errors based on the comparison.

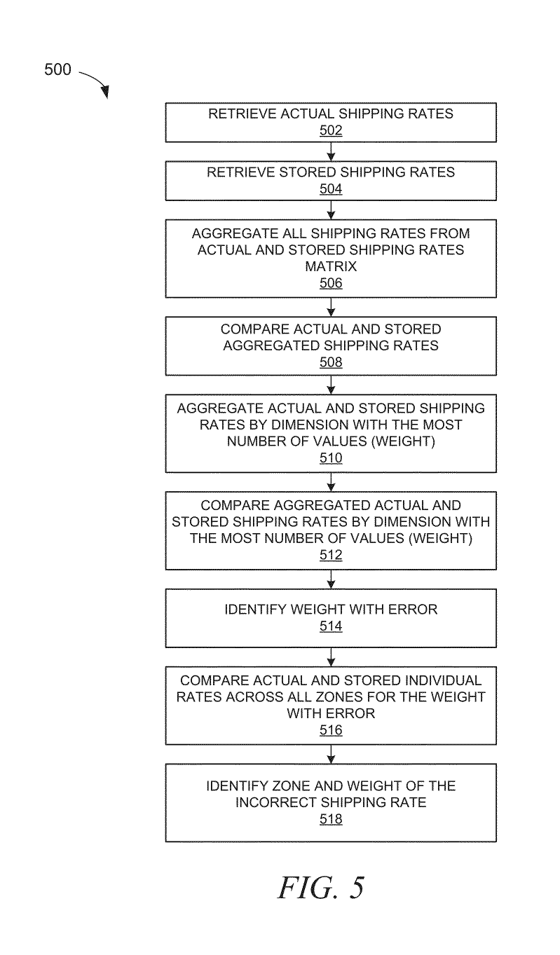

FIG. 5 is a flow diagram illustrating an example embodiment of a method 500 for validating shipping rates. At 502, the shipping rate validation application 234 retrieves actual or latest shipping rates from a shipping service provider. At 504, the shipping rate validation application 234 retrieves shipping rates currently stored or last retrieved by the shipping rate validation application 234. The shipping rates may include a multi-dimensional matrix or tables. At 506, the shipping rate validation application aggregates all the shipping rates from the actual and stored shipping rates matrices. At 508, the shipping rate validation application compares the actual and stored aggregated shipping rates. At 510, the shipping rate validation application aggregates actual and stored shipping rates by dimension with the most number of fields or values (e.g., weight). At 512, the shipping rate validation application compares the aggregated actual and stored shipping rates by dimension with the most number of fields or values (e.g., weight). For example, a shipping rate table may have more fields for the weight (e.g., 1 oz, 5 oz, 10 oz, etc.) than fields for the shipping zone (e.g., zone 1, zone 2, etc.). At 514, the shipping rate validation application identifies the corresponding weight field having an error.

At operation 516, the shipping rate validation application compares the actual and stored individual rates across all shipping zones for the corresponding weight field with the error.

At operation 518, the shipping rate validation application identifies the shipping zone and weight of the incorrect shipping rate.

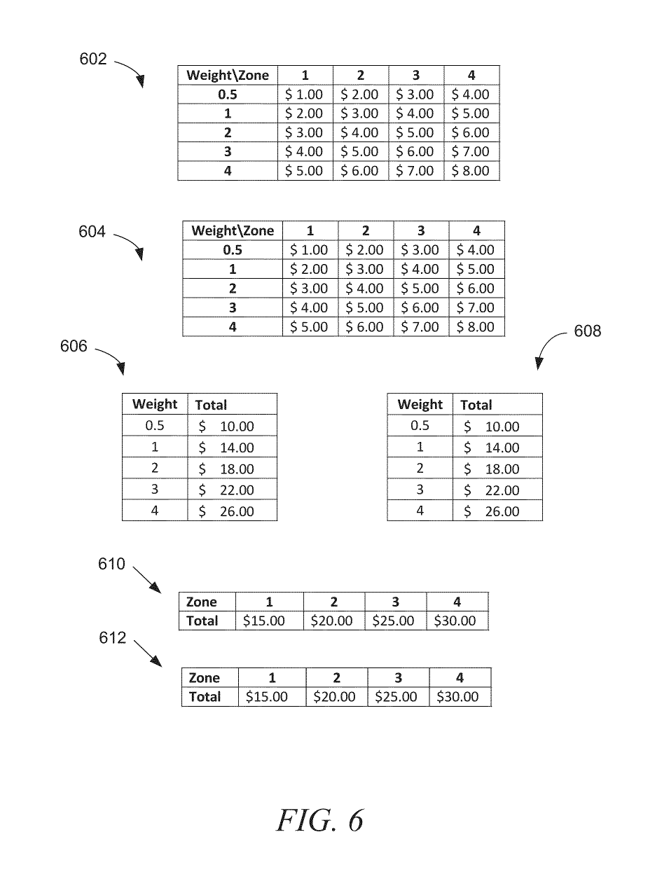

FIG. 6 illustrates examples of shipping rate tables being processed by the shipping rate validation application. Table 602 illustrates an actual shipping rate table. The aggregate rate value of the actual shipping rate of table 602 for the entire matrix is $90. Table 604 illustrates a stored shipping rate table already loaded in the marketplace application system. The aggregate rate value of the actual shipping rate of table 604 for the entire matrix is also $90.

Table 606 illustrates an actual weight aggregate where the rate values are aggregated by weight (matrix vector with the highest number of values). Table 608 illustrates a stored weight aggregate where the rate values are aggregated by weight (matrix vector with the highest number of values). The values in tables 606 and 608 are compared with each other. In this example, the values are the same.

Table 610 illustrates an actual zone aggregate where the rate values are aggregated by zone (matrix vector with the lower number of values). Table 608 illustrates a stored zone aggregate where the rate values are aggregated by zone (matrix vector with the lower number of values). The values in tables 606 and 608 are compared with each other. In this example, the values are the same. Based on the comparison of tables 602 with 604, 606 with 608, and 610 with 612, the rates have been loaded successfully and are thus valid.

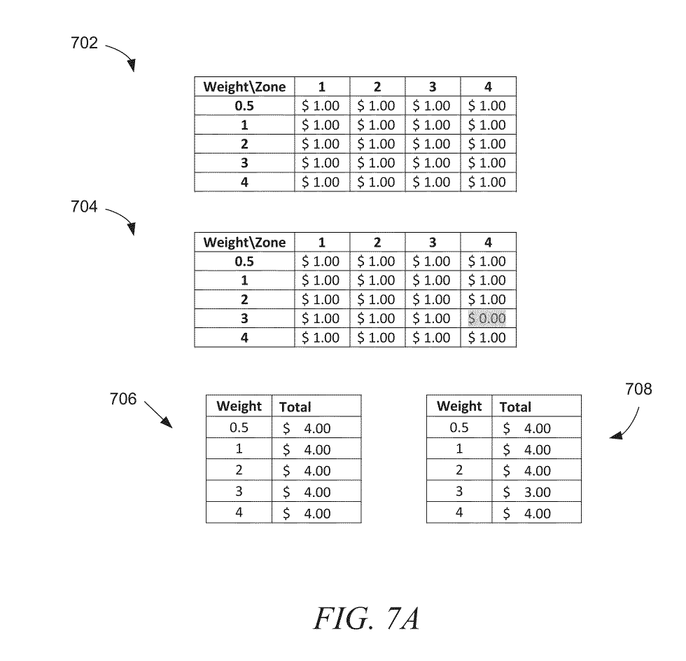

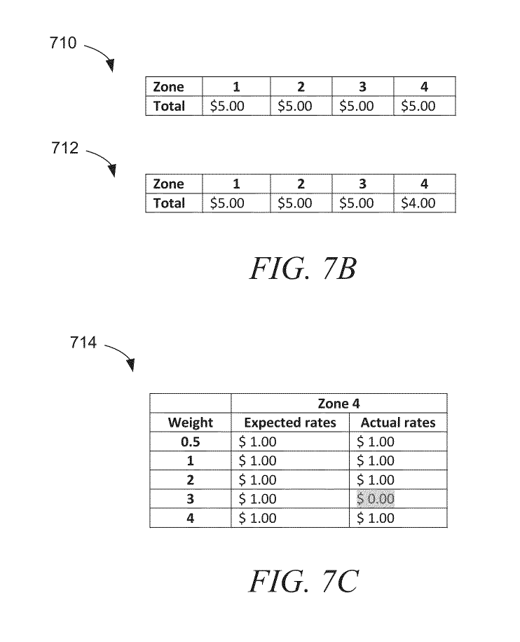

FIGS. 7A, 7B, 7C illustrate examples of shipping rate tables being processed by the shipping rate validation application. Table 702 illustrates an example of an actual rate table. The aggregated rate value for the entire matrix of table 702 is $20. Table 704 illustrates an example of a stored rate table with the shipping rate error highlighted. The aggregated rate value for the entire matrix of table 704 is $19. Because of the mismatched aggregated value, the system detects that the shipping rate table is not up to date in the system.

Table 706 illustrates aggregated rate values by weight based on table 702. Table 708 illustrates aggregated rate values by weight based on table 704. The comparison of table 706 and 708 indicates that the total rate value for the 3 lbs weight is different. In case of error, there are two options:

A first approach may be applied when efficiency is not a constraint. As the number of vectors with rate mismatches increase, the efficiency of this approach improves. For example, table 710 shows aggregated values by zones based on table 702. Table 712 shows aggregated values by zones based on table 712. The comparison of table 710 and 712 indicates that the total rate value for zone 4 is different. Based on both comparisons, the shipping rate error is identified in zone 4, weight 3 lbs.

A second approach may be applied when the size of the matrix is large and aggregating totals is resource expensive. Individual rate values across all zones for the weight slab that has the error are compared. Table 714 illustrates an example of the comparison using the second approach. The mismatch is identified for weight slab 3 lbs. The incorrect rate value has been identified for Zone 4 and weight 3 lbs.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein, as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses that connect the modules). In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

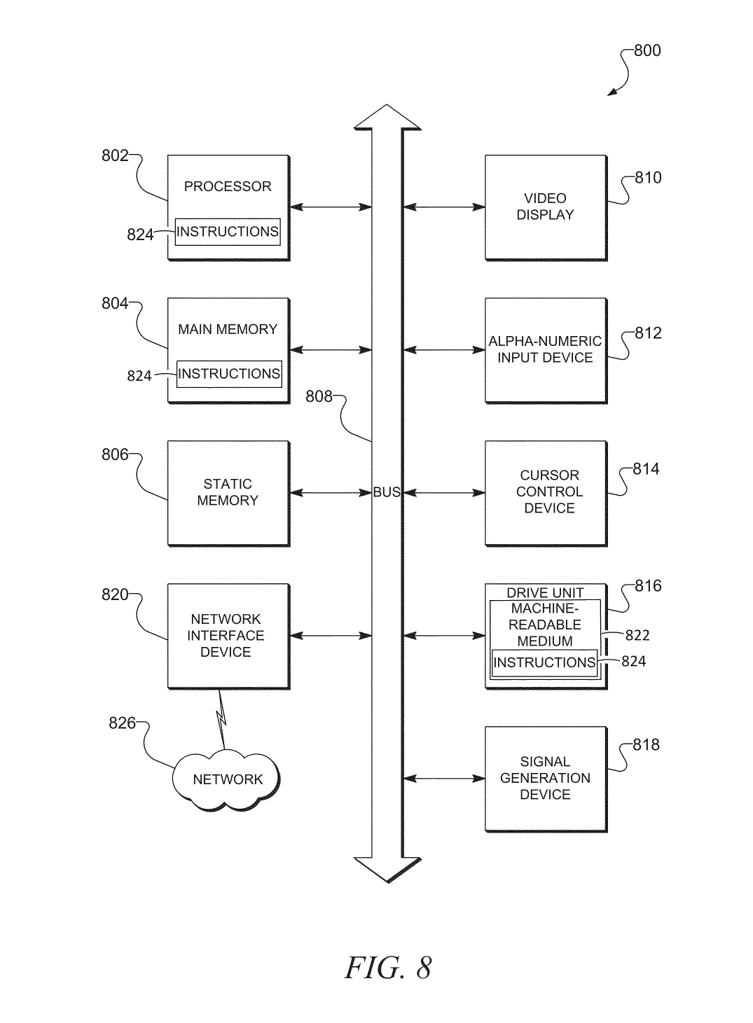

FIG. 8 shows a diagrammatic representation of a machine in the example form of a computer system 800 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a UI navigation device 814 (e.g., a mouse), a disk drive unit 816, a signal generation device 818 (e.g., a speaker), and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media 822.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that stores the one or more sets of instructions. The term “machine-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “machine-readable medium” shall accordingly be taken to include, but not be limited to, solid-state memories, optical media, and magnetic media. Specific examples of machine-readable storage media include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and CD-ROM and DVD-ROM disks.

What is claimed is:

1. A system comprising:
a processor of a machine;
a shipping rate validation application executable by the processor and configured to:
retrieve an actual shipping rates table and a stored shipping rates table;
compute, using the processor of the machine, a first aggregate value from the sum of all values in the actual shipping rates table, and a second aggregate value from the sum of all values in the stored shipping rates table;
compare the first aggregate value with the second aggregate value;
compute a third aggregate value along a field with the most number of values of the actual shipping rates table, and a fourth aggregate value along a field with the most number of values of the stored shipping rates table;
compare the third aggregate value with the fourth aggregate value; and
validate the stored shipping rates table when the first aggregate value matches the second aggregate value, and the third aggregate value matches the fourth aggregated value.

2. The system of claim 1, wherein the shipping rate validation application is further configured to:
identify a field having an error in the stored shipping rates table based on the comparison between the third aggregate value with the fourth aggregate value;
compute a fifth aggregate value along a field with the least number of values of the actual shipping rates table, and a sixth aggregate value along a field with the least number of values of the stored shipping rates table; and
compare the fifth aggregate value with the sixth aggregate value to identify a shipping rate error within the field having the error in the stored shipping rates table.

3. The system of claim 2, wherein the shipping rate validation application is configured to:
validate the stored shipping rates table based on the comparison between the first aggregate value with the second aggregate value, between the third aggregate value with the fourth aggregate value, and between the fifth aggregate value with the sixth aggregate value.

4. The system of claim 1, wherein the shipping rate validation application is configured to:
reduce the actual and stored shipping rates tables to a two-dimensional matrix having shipping weight fields as a first dimension and shipping zone fields as a second dimension;
identify a shipping weight field having the shipping rate error by comparing aggregated values along the shipping zone fields; and
identify the shipping zone field having the shipping rate error by comparing values along the identified shipping weight field.

5. The system of claim 1, wherein the field with the most number of values includes a shipping weight field; and
wherein the field with the least number of values includes a shipping zone field.

6. The system of claim 1, wherein the shipping rate validation application is configured to:
retrieve an actual shipping rates table for a shipping service and a stored shipping rates table for the shipping service; and
compute an actual service aggregate value based on the sum of all values in the actual shipping rates table for the shipping service, and a stored service aggregate value from the sum of all values in the stored shipping rates table for the shipping service.

7. The system of claim 1, wherein the shipping rate validation application is configured to:
retrieve the actual shipping rates table for a shipping service of a shipping service provider from a server associated with the shipping service provider; and
retrieve the stored shipping rates table for the shipping service of the shipping service provider from a database of an online marketplace application.

8. The system of claim 1, wherein the shipping rate validation application is configured to:
retrieve an actual shipping rates table corresponding to a seller tier of an online marketplace application; and
compute an actual service aggregate value based on the sum of all values in the actual shipping rates table for the corresponding seller tier, and a stored service aggregate value from the sum of all values in the stored shipping rates table for the corresponding seller tier.

9. The system of claim 1, further comprising:
a storage device configured to store shipping rates tables with corresponding shipping services, shipping service providers, and seller tiers.

10. The system of claim 1, wherein the shipping rate validation application is configured to:
communicate with a plurality of servers associated with corresponding shipping service providers to retrieve actual shipping rates tables; and
generate a shipping label to a seller of an online marketplace after validating the stored shipping rates tables.

11. A method comprising:
retrieving an actual shipping rates table and a stored shipping rates table;
computing, using a processor of a machine, a first aggregate value from the sum of all values in the actual shipping rates table, and a second aggregate value from the sum of all values in the stored shipping rates table;
comparing the first aggregate value with the second aggregate value;
computing a third aggregate value along a field with the most number of values of the actual shipping rates table, and a fourth aggregate value along a field with the most number of values of the stored shipping rates table;
comparing the third aggregate value with the fourth aggregate value; and
validating the stored shipping rates table when the first aggregate value matches the second aggregate value, and the third aggregate value matches the fourth aggregated value.

12. The method of claim 11, further comprising:
identifying a field having an error in the stored shipping rates table based on the comparison between the third aggregate value with the fourth aggregate value;
computing a fifth aggregate value along a field with the least number of values of the actual shipping rates table, and a sixth aggregate value along a field with the least number of values of the stored shipping rates table; and
comparing the fifth aggregate value with the sixth aggregate value to identify a shipping rate error within the field having the error in the stored shipping rates table.

13. The method of claim 12, further comprising:
validating the stored shipping rates table based on the comparison between the first aggregate value with the second aggregate value, between the third aggregate value with the fourth aggregate value, and between the fifth aggregate value with the sixth aggregate value.

14. The method of claim 11, further comprising:
reducing the actual and stored shipping rates tables to a two-dimensional matrix having shipping weight fields as a first dimension and shipping zone fields as a second dimension;
identifying a shipping weight field having the shipping rate error by comparing aggregated values along the shipping zone fields; and
identifying the shipping zone field having the shipping rate error by comparing values along the identified shipping weight field.

15. The method of claim 11, wherein the field with the most number of values includes a shipping weight field; and
wherein the field with the least number of values includes a shipping zone field.

16. The method of claim 11, further comprising:
retrieving an actual shipping rates table for a shipping service and a stored shipping rates table for the shipping service; and
computing an actual service aggregate value based on the sum of all values in the actual shipping rates table for the shipping service, and a stored service aggregate value from the sum of all values in the stored shipping rates table for the shipping service.

17. The method of claim 11, further comprising:
retrieving the actual shipping rates table for a shipping service of a shipping service provider from a server associated with the shipping service provider; and
retrieving the stored shipping rates table for the shipping service of the shipping service provider from a database of an online marketplace application.

18. The method of claim 11, further comprising:
retrieving an actual shipping rates table corresponding to a seller tier of an online marketplace application; and
computing an actual service aggregate value based on the sum of all values in the actual shipping rates table for the corresponding seller tier, and a stored service aggregate value from the sum of all values in the stored shipping rates table for the corresponding seller tier.

19. The method of claim 11, further comprising:
storing shipping rates tables with corresponding shipping services, shipping service providers, and seller tiers.

20. A non-transitory computer-readable storage medium storing a set of instructions that, when executed by a processor, cause the processor to perform operations, comprising:
retrieving an actual shipping rates table and a stored shipping rates table;
computing, using a processor of a machine, a first aggregate value from the sum of all values in the actual shipping rates table, and a second aggregate value from the sum of all values in the stored shipping rates table;
comparing the first aggregate value with the second aggregate value;
computing a third aggregate value along a field with the most number of values of the actual shipping rates table, and a fourth aggregate value along a field with the most number of values of the stored shipping rates table;
comparing the third aggregate value with the fourth aggregate value; and
validating the stored shipping rates table when the first aggregate value matches the second aggregate value, and the third aggregate value matches the fourth aggregated value.
